(19) United States
(12) Patent Application Publication
(10) Pub. No.: US 2008/0134891 A1
(43) Pub. Date: Jun. 12, 2008

(54) Method and Apparatus for Purifying Combustion Gases of Impurities Contained in the Combustion Gases

(75) Inventor: Viljo Jarvenpaa, Kerava (FI)

Correspondence Address: WOLF, BLOCK, SHORR AND SOLIS-COHEN LLP, 250 PARK AVENUE, 10TH FLOOR, NEW YORK, NY, 10177, US

(73) Assignee: VSJ Holding Oy, Kerava (FI)

(21) Appl. No.: 11/813,239

(22) PCT Filed: Feb. 3, 2006
(86) PCT No.: PCT/FI06/00029

§ 371 Date: Dec. 20, 2007

(30) Foreign Application Priority Data
Feb. 7, 2005 (FI) 20050141

(51) Int. Cl. B01D 47/10; B01D 19/00

(52) U.S. Cl. 95/205; 96/188

(57) ABSTRACT

The invention concerns a method and an apparatus for purifying combustion gases, especially combustion gases exhausted from maritime diesel engines and combustion gases produced by power plants situated near the seaside, of impurities contained in the combustion gases. The apparatus comprises a scrubber device (10) for scrubbing the combustion gases and a droplet separator device (20) for separating scrubbing liquid droplets from the outflowing purified combustion gas flow (D). The scrubber device (10) comprises an inflow duct (13) for conveying an overpressurised combustion gas flow (A) containing impurities into the scrubber device (10) and means (16,17,18) for passing seawater used as scrubbing liquid into the scrubber device (10). At least the scrubbing liquid flowing out of the scrubber device (10) has been fitted to flow into the flotation device (30) for the separation of soot particles, oil and other possible solid impurity particles contained in the scrubbing liquid from the scrubbing liquid.

The present invention relates to a method as defined in the preamble of claim 1 and an apparatus as defined in the preamble of claim 6.

It is known that the combustion gases produced by a diesel engine flow out of the engine under an overpressure as high as 5000 Pa. It is likewise known that the oxygen content of the combustion gases is of the order of about 12 percent by volume, in other words, the air coefficient in the combustion is about 2. As the temperature of the gases may simultaneously reach a level of even 400-600° C., the conditions are exceptional.

The fuel used in most large maritime engines is heavy diesel oil, which may have a sulphur content of as much as 4-5 percent by weight. As a result of this, many ports are imposing restrictions on the use of heavy diesel oil in the port area, and consequently vessels have to use light diesel oil in port traffic. The use of light diesel oil costs multiple times as much as heavy diesel oil. Therefore, it would be economical to find a solution for purifying the combustion gases of engines puffing out soot to as complete a degree as possible.

Cruisers usually sail in warm waters, such as the Caribbean Sea, where the climate is favourable for recreation e.g. at the swimming pool of the vessel while sailing on the sea. If the soot particles in the combustion gases emitted by the diesel engine contaminate e.g. lightly clothed people spending time at the swimming pool, there may arise even high compensation claims if white swimwear/beachwear is soiled by the soot particles emitted.

Of course it is possible to find many solutions for the purification of combustion gases, but they are not reasonably applicable to the purpose in question. By using an electric filter, soot and other solid particles can be removed, but sulphur dioxide can not. The same applies to a dry filter. In dry filters, however, heat resistance is a limiting factor, so it is necessary to use cooling air, which increases the size of the filter too much. A dry filter is also incapable of removing sulphur emissions. On the other hand, if a wet scrubber is used with the actual conventional approach, the apparatus will be too expensive and complicated, to say nothing of the extensive neutralisation it requires. For these reasons, maritime diesel engines have been made as clean-running as possible to reduce their exhaust gas emissions, and shipowners have faced the necessity to resort either to low-sulphur or sulphur-free fuel, which has resulted in considerable economical costs.

When a diesel engine uses heavy fuel with a sulphur content of 4-6 percent by weight, the combustion gases contain both sulphur dioxide and oil vapours. The combustion gases also contain carbon and other solid particles, the separation of which is difficult and requires extraordinary solutions. Scrubbing of the combustion gases of maritime diesel engines can be implemented e.g. according to patent specifications WO 0208541 and WO 9944722 with satisfactory scrubbing results. The problem, however, are the droplets contained in the gases after the scrubbing and the oil and fine particles remaining in the scrubbing water. Such contaminated water released from the vessel may form on the water surface a wake of pollution that may endure and remain visible even for a long time as the ship is moving in open sea.

The object of the present invention is to achieve an improvement in the currently known methods and equipments for purifying combustion gases of impurities contained in the combustion gases. A specific object of the invention is to achieve a method and apparatus that will be applicable for purifying in a sufficiently efficient manner especially the combustion gases produced by maritime diesel engines and power plants situated near the seaside.

The objects of the invention are achieved by a method which is characterised by the features presented in the characterisation part of claim 1. The apparatus of the invention is characterised by the features presented in the characterisation part of claim 6.

The method and apparatus of the invention provide numerous significant advantages. Using the solution of the invention, combustion gases can be purified sufficiently effectively, so that for example from the chimney of a ship no impurity particles or droplets objectionable to the passengers can fly out. The wash liquid after the scrubber and droplet separator still contains impurities, such as e.g. soot, oil and other solids, of which the liquid is purified via flotation, with the result that the sea water used as wash liquid and flowing out of the vessel into the sea is almost clean and therefore does not pollute marine regions.

The scrubber solution of the invention is exceptional in that it does not necessarily require a blower at all. This is because the combustion gas flow coming out of diesel engines which is to be scrubbed is under an overpressure. If that is not the case directly as the gas is exhausted from the engine, it can naturally be ovepressurised by using a blower, or the scrubber can be provided with a blower. However, the combustion gases of maritime diesel engines are under a sufficient overpressure to ensure that they will easily flow through the disclosed scrubbing process, which normally involves a pressure drop of 1200-1500 Pa. As there is additionally plenty of wash liquid available in the sea and as the combustion gas is nearly perfectly scrubbed, the solution of the invention produces a purification result wherein the exhaust gases from the chimney of a ship contain no environmentally noxious amounts of impurities or harmful gas emissions even when heavy fuel oil is used.

It is also possible to replace the filling layer with only an intensive liquid mist spray, but in this case the scrubbing performance will not necessarily be as good as in a solution provided with a filling layer because the time of contact between the combustion gas to be scrubbed and the scrubbing liquid solution remains too short for e.g. sulphur dioxide to be dissolved in the scrubbing liquid to a sufficient degree.

The solution of the invention is an economical solution of light and small mechanical construction for the scrubbing of combustion gases. It can also be used in other applications besides ships, e.g. for similar gas scrubbing purposes in power plants situated near the sea.

The placement of the inflow channel for the combustion gas to be scrubbed can be selected relatively freely, but the most advantageous solution is from above downwards, in which case the spraying nozzle can moisten the inflow channel wall while at the same time effectively cooling down the combustion gas flow.

The inflow of the combustion gas to be scrubbed may also take place via a separate cooling and moistening inlet section. The flotation basin may be placed relatively freely, even in a place completely separate from the scrubbing solution itself.

By using the method and apparatus of the invention, solids can be removed from the combustion gases and at the same time sulphur dioxide can be transferred for dissolution in the scrubbing water, which is taken directly from the sea and discharged back into the sea by purifying the scrubbing water by the solution of the invention before letting it out into the sea. As the combustion gas is simultaneously oxygenous and the pH of the scrubbing water is within a suitable range, i.e. in the so-called bisulphite range, the scrubbing water is oxidised into sulphuric acid, which again reacts with magnesium carbonate, among other substances, present in the sea water. In this way, carbonic acid is released, which is a weak acid. This means that the sulphur is transferred into the water and does not cause a so-called acid rain, which would be the final result of sulphuric acid getting freely into the atmosphere. A further essential feature of the invention is that the scrubbed combustion gas is conveyed via an independent droplet separating unit, where any droplets that may still remain in the scrubber combustion gas are eliminated from the purified combustion gas flow before it is blown out.

The invention is applicable for scrubbing the exhaust gases of a diesel engine to remove sulphur dioxide and soot particles from them, so that the gases blown out are simultaneously droplet-free.

An insight implemented in the method of the invention is to use a wet scrubber without a blower, in which wet scrubber the scrubbing and neutralising liquid is oxygen-rich seawater and which is preferably provided with a filling layer. In the wet scrubber, the scrubbed combustion gas cooled down after the scrubbing is dried by passing it through a droplet separator before its being blown out, and the scrubbing water is conveyed into a flotation stage, from where it returns into the sea.

The invention will now be described in detail by referring to a few preferred embodiments of the invention illustrated in the figures of the attached drawings, to which embodiments the invention is not exclusively confined.

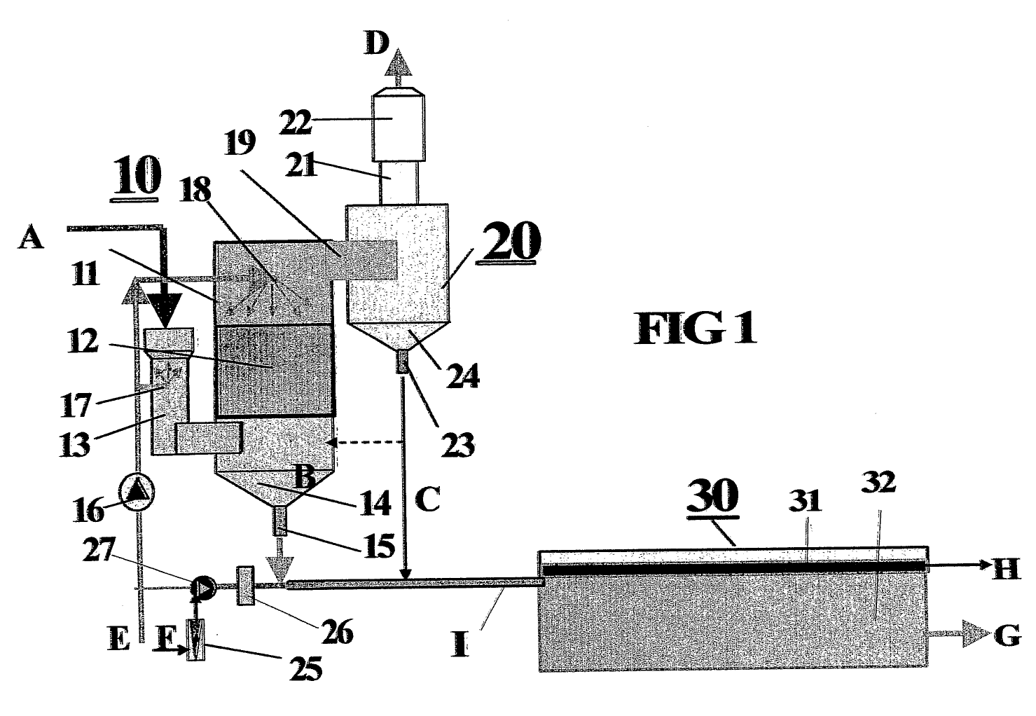

FIG. 1 presents a diagrammatic side view of a preferred embodiment of the method and apparatus of the invention.

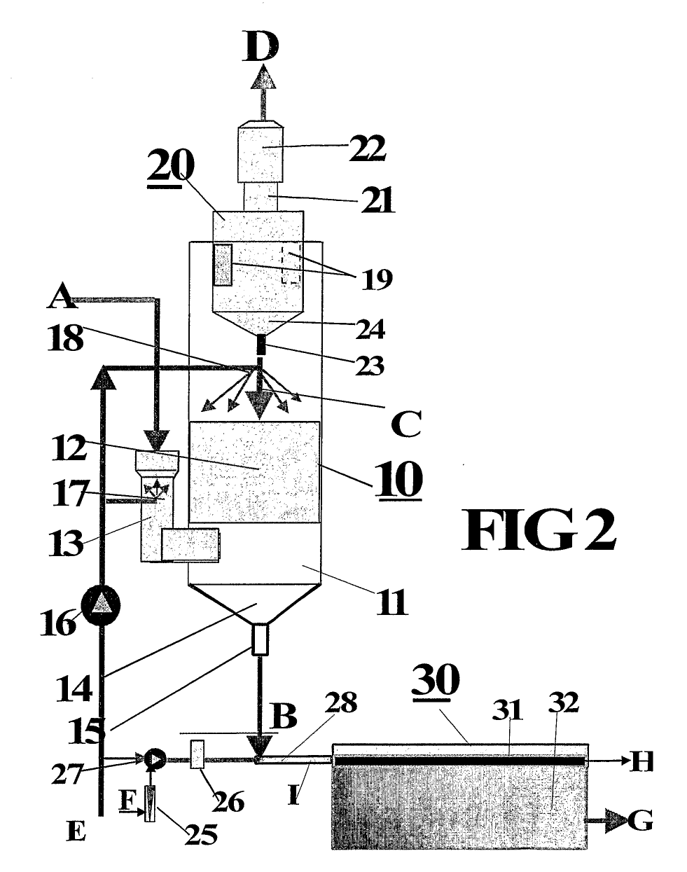

FIG. 2 presents a diagrammatic side view of a second preferred embodiment of the method and apparatus of the invention.

FIG. 1 is a preferred embodiment of the method and apparatus of the invention. In this embodiment, the apparatus of the invention comprises a scrubber device 10, a droplet separator device 20 and a flotation device 30. The combustion gas flow A exhausted from a diesel engine is generally under an overpressure of about 5000 Pa. The temperature of the combustion gas is 400-600° C., which is why the combustion gas is cooled down by a liquid spray 17 already in the inflow duct 13. After the inflow duct 13, the combustion gas and the scrubbing liquid sprayed into it are separated from each other mainly in the cyclone-like lower end 11 of a filling-layer type scrubber 10, and the cooling and pre-moistening water is separated from the cone 14 via a duct 15 as flow B. The gas flow continues upwards through the filling layer 12. An intensive spray 18 of scrubbing liquid is applied to the upper surface of the filling layer 12 from above. As this scrubbing liquid flows through the filling layer 12 in the opposite direction relative to the gas flow, detrimental components, such as e.g. SO₂ gas, present in the combustion gases are dissolved in the liquid. At the same time, the scrubbing liquid separates solid particles, such as e.g. soot particles, from the combustion gas flow. Thus, the combustion gas flowing out into conduit 19 has been purified of detrimental components and solid particles while the scrubbed combustion gas is over-saturated and contains considerable amounts of water droplets, among other things. In the filling-layer type scrubber 10 described, the scrubbed combustion gas now flows into the cyclone section 29 of the droplet separator 20, from whose bottom cone 24 the separated water is removed via a discharge opening 23 as flow C. The combustion gas now mainly free of droplets continues flowing towards the outlet while rapidly revolving along a tubular duct 21. This revolving motion continues into an auxiliary droplet separator 22, which is placed on the top of the chimney and in which the remaining droplets in the outer periphery of the revolving gas flow are separated from the purified gas flow D flowing out. In the solution of the invention, all scrubbing liquid droplets separated are passed out of the droplet separator 20 as flow C.

The spraying water 17 and 18 is supplied by a pump 16, which according to the invention takes the scrubbing liquid from the sea as flow E. Thus, the scrubbing water, besides containing 8-10 mg/l oxygen and carbon dioxide CO₂, also contains other normal salts present in seawater, the most important of which are magnesium and Mg salts. These neutralise the sulphur in the diesel engine's combustion gas in SO₂ form. As it is dissolved in water, sulphur dioxide forms sulphurous acid H₂SO₃, which dissociates into bisulphite ion H⁺, i.e. hydrogen ion in pH range 3-5.5. When bisulphite ion is oxidised into sulphate ion, each sulphur mole theoretically requires half a mole of oxygen. Thus, each kilogram of sulphur in the fuel requires at least half a kilogram of oxygen for the sulphite to be converted into sulphate. As sulphur dioxide is dissolved in water during the scrubbing, the scrubbing water should contain the above-mentioned quantity of oxygen (8 mg/l on an average) dissolved in it. If heavy fuel has a sulphur content of 5 percent by weight, this corresponds to 0.156 kmol of SO₂ gas. A corresponding number of kilomoles of hydrogen forms from these an equal number of kilomoles of sulphurous acid H₂SO₃. Oxidising such a quantity of sulphurous acid into sulphuric acid requires about 8.75 m³ of air. As diesel engines use at least twice as much combustion air in stoichiometric quantities, such an amount of air easily permits the entire sulphur content to be oxidised into sulphate. As seawater additionally contains oxygen (min. 8 mg/i) and also at least 2 percent by weight of salts, and most of these on Mg basis too, this is a situation where the sulphur in the fuel is in the form of Mg sulphate and neutralised by carbonates. Therefore, the most suitable amount of scrubbing water can be double in proportion to the amount of weight of the combustion gases.

The scrubbing water flows B and C coming out from the scrubbing stage can also be combined or conveyed as separate flows into channel 28 to form flow I. If necessary, it is also possible to supply a suitable flocculating chemical into this scrubbing liquid flow I, but it is essential to add micro-bubbles into this scrubbing liquid flow. These adhere to oil droplets present in the outbound scrubbing liquid flow I, and also to solids, which mostly consist of soot particles. This water flow is passed into the flotation device 30, where the micro-bubbles raise both the oil droplets and solid particles to the surface of the flotation basin, from where they are removed as flow H. The clean water is discharged as flow G, which is free of impurities but still contains sulphate ions. Water thus purified will not produce any wake of emissions or any other perceptible detrimental effect on the sea.

The micro-bubbles are preferably produced by a pump solution 27, wherein a gas, preferably air, is mixed in water taken from the sea as flow E or as a flow taken separately. The gas used may also be oxygen. As the pump 27 sucks air as flow F controlled by a volume flow meter 25 and water into the pump chamber, the impeller of the pump 27 mixes the air so as to form small bubbles in the chamber of the pump 27. In this case, flow F is preferably at most 10 percent by volume of the amount of water taken in by the pump 27. As the pressure in the pump 27 increases even to 4-10 bar, the small bubbles are dissolved in water, and the water containing air thus dissolved is discharged out of the pump 27, whereupon the pressurised water is released via a nozzle 26, producing micro-bubbles, the most suitable size of which is 5-30 μm. With this arrangement, even 2-μm solid particles can be brought to the surface of the flotation basin before being removed from the flotation basin as flow G. Oil and solid particles having risen to the surface of the flotation basin can be easily removed as flow H.

The embodiment according to FIG. 2 is otherwise identical to the embodiment presented in FIG. 1 but with the difference that conduit 19 is superfluous and the droplet separator cyclone 20 is inside an extended filling-layer scrubber 10 so that it goes at least to the level of the upper part of the conduit 19. The gas now flows into the cyclone section 29 of the droplet separator 20 through openings 19, which guide the gas into the vortex in the cyclone section of the droplet separator 20. The water flow C separated from the droplets flows directly through the filling layer 12. This construction is well suited for solutions where a tower-type scrubbing function is desired and where height is available as needed.

In the foregoing, only a few preferred embodiments of the invention have been described, and it is obvious to the person skilled in the art that numerous modifications can be made in them within the scope of the inventive concept presented in the claims below.

1. A method for purifying combustion gases, especially combustion gases exhausted from maritime diesel engines and combustion gases produced by power plants :situated near the seaside, of impurities contained in the combustion gases, in which method the combustion gases are purified via liquid scrubbing in a scrubber device (10) and the scrubbing liquid droplets are separated from the outflowing purified combustion gas flow (D), characterized in that the combustion gases to be purified are passed as an overpressurised combustion gas flow (A) into the scrubber device (10) and seawater used as scrubbing liquid is passed as flow (E) into the scrubber device (10), the combustion gas flow (A) containing impurities and the scrubbing liquid flow (E) being brought into mutual contact in the aforesaid scrubber device (10), and that at least the scrubbing liquid consisting of seawater and flowing out of the aforesaid scrubber device (10) is caused to flow as flow (B,I) into a flotation device (30) for the separation of soot particles, oil and other possible solid impurity particles contained in the aforesaid scrubbing liquid from the aforesaid scrubbing liquid via flotation.

2. A method according to claim 1, wherein a the combustion gas flow (A) containing impurities which flows into the scrubber device (10) is pre-cooled by a first liquid spray (17) consisting of seawater.

3. A method according to claim 1, wherein a filling layer (12) provided in the scrubber device (10) is cooled by a second liquid spray (18) consisting of seawater.

4. A method according to claim 1, wherein a droplet separator device (20) is placed substantially inside the scrubber device (10).

5. A method according to claim 1, wherein seawater containing micro-bubbles is passed as flow (I) into the flotation device (30).

6. An apparatus for purifying combustion gases, especially combustion gases exhausted from maritime diesel engines and combustion gases produced by power plants situated near the seaside, of impurities contained in the combustion gases, said apparatus comprising a scrubber device (10) for scrubbing the combustion gases and a droplet separator device (20) for separating scrubbing liquid droplets from the outflowing purified combustion gas flow (D), characterized in that the scrubber device (10) comprises an inflow duct (13) for conveying an overpressurised combustion gas flow (A) containing impurities into the scrubber device (10) and means (16,17,18) for passing seawater used as scrubbing liquid into the scrubber device (10), and that at least the scrubbing liquid flowing out of the aforesaid scrubber device (10) has been fitted to flow into the flotation device (30) for the separation of soot particles, oil and other possible solid impurity particles contained in the scrubbing liquid from the scrubbing liquid.

7. An apparatus according to claim 6, wherein the scrubber device (10) is provided with a filling layer (12), through which the combustion gases to be purified have been fitted to flow.

8. An apparatus according to claim 6, wherein the scrubber device (10) comprises a first liquid spray (17) consisting of seawater for pre-cooling the combustion gas flow (A) containing impurities which flows into the scrubber device (10).

9. An apparatus according to claim 7, wherein the scrubber device (10) comprises a second liquid spray (18) consisting of seawater for cooling the filling layer (12).

10. An apparatus according to claim 6, wherein the droplet separator device (20) is placed substantially inside the scrubber device (10).

11. An apparatus according to claim 6, wherein the droplet separator device (20) comprises an auxiliary droplet separator (22), through which the outflowing purified combustion gas flow (D) has been fitted to flow before it finally flows out.

12. An apparatus according to claim 6, wherein the apparatus comprises a first pump device (16) for passing seawater into the scrubber device (10).

13. An apparatus according to claim 6, wherein the apparatus comprises a second pump device (27) for creating micro-bubbles, which are needed in flotation, in the said second pump device (27) from a gaseous medium flow (F) dissolved in the seawater.

14. An apparatus according to claim 6, wherein the apparatus comprises a flow conduit (28) through which scrubbing liquid streams (B,C) that may still contain impurities have been fitted to flow into the flotation device (30).

15. An apparatus according to claim 15, wherein the said 15 seawater containing micro-bubbles has been fitted to flow through the said flow conduit (28) into the flotation device (30).
